(19) United States
(12) Patent Application Publication
(10) Pub. No.: US 2026/0239094 A1
(43) Pub. Date: Aug. 13, 2026

(54) METHODS AND DEVICES FOR HANDLING SUPPORT FOR EXTENDED REALITY AND MEDIA SERVICES IN 5GS

(71) Applicant: Google LLC, MOUNTAIN VIEW, CA (US)

(72) Inventor: Ching-Yu LIAO, Mountain View, CA (US)

(21) Appl. No.: 19/153,876

(22) PCT Filed: Feb. 9, 2024
(86) PCT No.: PCT/US2024/015222

§ 371 Date: Aug. 5, 2025

Related U.S. Application Data
(60) Provisional application No. 63/484,460, filed on Feb. 10, 2023.
(60) Provisional application No. 63/495,074, filed on Apr. 7, 2023.

(51) Int. Cl. H04W 28/02; H04W 4/24; H04W 12/06; H04W 48/16

(52) U.S. Cl. CPC H04W 28/0268; H04W 4/24; H04W 12/06; H04W 48/16

(57) ABSTRACT

Methods and devices in a wireless communication system are directed to establishing an extended reality and/or media, XRM, service traffic between a user equipment, UE, and a data network. A core network, CN, element of the system receives, from a user equipment, UE, a single-network slice selection assistance information, S-NSSAI, for the XRM service, or an XRM capability of the UE. The CN element sends packet data unit, PDU, set based quality-of-service, QoS, parameters to a radio access network, RAN, node, and activates, at a user plane function, UPF, a PDU set based handling corresponding to the PDU set QoS parameters, for a PDU set based QoS flow for a PDU session associated to a network slice corresponding to a selected S-NSSAI.

### FIELD OF THE DISCLOSURE

This document generally describes methods and devices operating in wireless communication systems such as (but not limited to) the ones described in 5G standard documents, known as 3^{rd} Generation Partnership Project (3GPP) communication systems.

### BACKGROUND

This background description is provided for the purpose of generally presenting the context of the disclosure and the technical problems. Work of the presently named inventors, to the extent it is described in this background section, as well as aspects of the description that may not otherwise qualify as prior art at the time of filing, are neither expressly nor impliedly admitted as prior art against the present disclosure.

5G networks are configured to support a variety of services with highly variable Quality-of-Service (QOS) requirements. This flexibility makes the 5G networks suitable for a multitude of extended reality (XR) and/or media (XRM) services. Currently, for the XRM data traffic between a user equipment (UE) and a core network (CN) element, a session management function (SMF) hosted by the CN element determines whether to enable a packet data unit (PDU) set based handling, based on policy and charging control (PCC) rules that contain PDU set based QoS parameters.

However, it is not clear how to provision QoS for the PDU set based on UE's XRM service capabilities and subscriptions because the current 5G network only checks whether the application function (AF) is authorized to request QoS for XRM services when receiving the AF request to create QoS flows with PDU set based QoS requirements. Further, it is not clear how to provision QoS for the PDU set when the network is sliced into plural network slices, that provide different service types, e.g., enhanced mobile broadband, ultra-reliable low latency communications, massive Internet of Things (IoT), voice, high-performance machine-type communications, high data rate and low latency communications, etc.

Also, it is not clear how to handle the QoS provisioning for the UE when some radio access network (RAN node) nodes support PDU set based QoS handling for XRM services and some other RAN nodes do not. For this heterogenous RAN node deployment, the AF may continue to request PDU set based QoS requirements to the CN, the application server (AS) may continue to transmit XRM service data to the 5G network, and various functions (e.g., access and mobility management function (AMF), SMF) of the CN would continue to manage PDU set based QoS flows and enforce corresponding configurations for PDU set handling based on the AF request although PDU set based QoS handling for XRM services might not be supported by the serving RAN node, which results in unnecessary signaling overheads for PDU set handling and waste of energy and computing powers.

### SUMMARY

According to an embodiment, when the UE initiates a registration request procedure with the CN element, the UE sends a registration request message that includes UE's XRM service capability. The UE may also send, to the SMF hosted by the CN element, a PDU session establishment or modification request message that includes a single-network slice selection assistance information (S-NSSAI) for XRM services. The S-NSSAI helps the CN element select a network function that fits the needs of the UE with regard to the XRM services. The CN element then configures the UE, the RAN node, and a PDU session anchor, PSA, user plane function, UPF for end-to-end XRM services.

In another embodiment, the access and mobility management function (AMF) of the CN is notified about the RAN node's XRM service capability for PDU Set based QoS handling, for provisioning required QoS for the XRM services. In one variation of this embodiment, the AF subscribes to an event exposure of the RAN node's XRM service capability for PDU Set based QoS handling so that the AF adjusts its XRM service requirements and the AS adjusts its XRM data traffic based on the availability of these services at the RAN node.

In yet another embodiment, the UE indicates its XRM service capability in the PDU session establishment or modification procedure, instead of the registration procedure. Alternatively, the UE does not indicate its XRM service capability, in either of these procedures, and the AMF sends one or more S-NSSAIs to the UE, independent of the UE XRM service capability.

### BRIEF DESCRIPTION OF THE DRAWINGS

The accompanying drawings, which are incorporated in and constitute a part of the specification, illustrate one or more embodiments and, together with the description, explain these embodiments.

FIG. 1 is a block diagram of a wireless communication system in which a UE and CN element perform methods according to various embodiments.

FIG. 2A is a signal diagram illustrating a modified registration request procedure in which the UE provides XRM service capability to the CN element according to an embodiment.

FIG. 2B is a flow chart illustrating the UE behavior for the procedures illustrated in FIG. 2A according to an embodiment.

FIG. 2C is a flow chart illustrating the AMF behavior for the procedures illustrated in FIG. 2B according to an embodiment.

FIG. 3A is a signal diagram illustrating a PDU establishment or modification procedure that uses the S-NSSAI for establishing the XRM service, according to an embodiment.

FIGS. 3B to 3D are flow charts illustrating the SMF, AMF, and UE behavior for the procedures illustrated in FIG. 3A according to an embodiment.

FIG. 4 is a signal diagram illustrating how the PCF configures the UE with XRM service authorization according to an embodiment.

FIG. 5 is a signal diagram illustrating AMF notification of RAN node's XRM service capability for PDU Set based handling according to an embodiment.

FIG. 6 is a signal diagram illustrating how the AMF obtains the RAN node's XRM service capability for PDU Set based handling based on an existing non-UE associated next generation application protocol (NGAP) procedure according to an embodiment.

FIG. 7 is a signal diagram illustrating how the AMF obtains the RAN node's XRM service capability for PDU Set based handling based on a new non-UE associated NGAP procedure according to an embodiment.

FIG. 8 is a signal diagram illustrating how the AMF obtains the RAN node's XRM service capability for PDU Set based handling based on an indication transmitted with a new non-UE associated NGAP procedure, according to an embodiment.

FIG. 9 is a signal diagram illustrating a scenario in which the AMF requests the RAN node's XRM service capability for PDU Set based handling based on a new UE associated NGAP procedure according to an embodiment.

FIG. 10 is a signal diagram illustrating how the AMF obtains the RAN node's XRM service capability for PDU Set based handling based on a new UE associated NGAP procedure according to an embodiment.

FIG. 11 is a signal diagram illustrating how the RAN node informs the AMF of the NG-RAN node's XRM service capability for PDU Set based handling based on a PDU session request according to an embodiment.

FIG. 12 is a signal diagram illustrating how the AF subscribes to event exposure to the AMF of the CN according to an embodiment.

FIG. 13 is a signal diagram illustrating how the AMF or SMF become aware of the NG-RAN node's XRM service capability for PDU Set based handling by using a new event identification according to an embodiment.

FIG. 14 is a signal diagram illustrating the UE using subscribed XRM services based on an initial context setup request message received from the AMF according to an embodiment.

FIG. 15 is a signal diagram illustrating a PDU session establishment or modification procedure modified so that the SMF provides an XRM service indication to the RAN node according to an embodiment.

### DETAILED DESCRIPTION

Methods and devices described in this section embody techniques related to XRM services in a wireless communication system. The embodiment descriptions in this section refer to the accompanying drawings. The same reference numbers in different drawings identify the same or similar elements. The detailed descriptions do not preclude other embodiments within the scope of the appended claims, for example, applying one or more methods to further RAN elements that might not be a RAN node. The embodiments are not limited to the described configurations but may be extended to other arrangements.

Reference throughout this section to “one embodiment” or “an embodiment” means that a particular feature, structure, or characteristic described in connection with an embodiment is included in at least one embodiment. Thus, the appearances of the phrases “in one embodiment” or “in an embodiment” in various places throughout the specification are not necessarily all referring to the same embodiment. Further, the particular features, structures or characteristics may be combined in any suitable manner in one or more embodiments.

Currently, the 5G system (5GS) lacks established procedures for some aspects of the interaction between the system (e.g., UE, RAN node, various functions of the CN element), and XRM applications, for example, provisioning QoS for UEs using XRM services when there are multiple network slices available. Various working groups of 3GPP were mandated to develop procedures for the 5G system to support advanced media services, e.g., High Data Rate Low Latency (HDRLL) services, AR/VR/XR services, and tactile/multi-modality communication services. The objectives of these groups include, among others, enhancements to the network exposure to support interaction between 5GS and XRM applications, and enhancements of QoS and policy for XRM service transmission.

As part of these developments, a PDU set was defined as including one or more PDUs carrying an application layer payload, which is associated with one unit of information, such as, for example, a video frame or video slice. A QOS flow may be enabled with a PDU set based QoS handling. All the PDUs of a PDU set are transmitted with the same QoS parameters in a QoS flow. The PDU set QoS parameters (e.g., PDU set delay budget, PDU set error rate, etc.) are used to support PDU set based QoS handling in the RAN node. At least one PDU Set QoS parameter shall be sent to the RAN node to enable PDU set based QoS handling.

A PDU set based QoS handling by the RAN node is determined by the PDU set QoS parameters (which are included in the QoS profile of the QoS flow, as specified in 3GPP Technical Specification (TS) 23.501) and PDU set information in the GTP-U header (GTP-U is a protocol employed by 5G for the user plane data transfer) provided by the PDU session anchor (PSA) user plane function (UPF). Note that the PSA UPF is typically the last UPF in the chain of UPFs that connects the UE to a data network (DN). The SMF instructs the UPF to perform PDU set identification and marking and may provide the UPF with the Protocol Description indicating the header (e.g., real time transport protocol (RTP)/secure RTP (SRTP)) and payload type (e.g. H.264) used by the service data flow(s) of a media stream from the application server. Based on the instructions from the SMF, for each downlink (DL) PDU received on an N6 interface for which PDU set based QoS handling should be performed, the PSA UPF applies the rules for PDU set identification and provides PDU set information, which is available to the RAN node in the GTP-U header.

To achieve XRM services support for PDU set based QoS handling in a 5G system, the RAN node needs to be aware of XRM services provided by the CN element and vice versa. The RAN node can be configured to handle PDU sets based on PDU set QoS parameters in the QoS profile if the SMF provides this info to the RAN node, over the N2 interface. Also, the RAN node needs to receive the PDU set information from the UPF, over the N3 interface, for the downlink XRM traffic, or to receive this information from the UE, over the Uu interface, for the uplink XRM traffic.

The 5G core (5GC) handles QoS provisioning based on the UE and RAN node's XRM services capabilities for PDU set based handling (also called “PDU set based QoS handling,” which may be represented as a PDU set based handling support indication). To support end-to-end PDU Set based QoS provisioning (between UE and DN, through the PSA UPF) for the XRM services, the 5GC needs to ensure that the PDU set handling for the XRM services is enabled for the UEs which support XRM service capabilities and subscribe to XRM services for PDU set handling. Currently, the 5GC only checks whether AF is authorized to request QoS of XRM services, when receiving an AF request to create QoS flows with PDU set based QoS requirements for the target UEs. Therefore, there is a need for mechanisms to enable PDU set based handling for the XRM services for the UE based on UE's XRM services capabilities and subscriptions.

In addition, in the early deployments of RAN nodes to support PDU set based handling for XRM services, the network may have RANs with and without XRM service capabilities for PDU set based handling. If the RAN node does not support XRM services capabilities for PDU set based handling, the RAN node would not perform PDU set based QoS handling for radio resource management based on PDU set based QoS parameters and PDU set information for the QoS flow of the XRM service for target UE.

For this scenario in which the network has RANs with and without XRM service capabilities for PDU set based handling, the end-to-end QoS provisioning for the XRM services becomes uncertain because the AF may continue to request PDU set based QoS requirements to the 5GC, the AS may continue to transmit XRM service data to the 5G network, and 5GC continues to manage PDU set based QoS flows and enforce corresponding configurations for PDU set based handling based on the AF request.

For example, in the downlink (DL), the PSA UPF may continue to perform deep packet inspection on PDUs in order to perform PDU set identification and marking as well as enforcing QoS for the PDUs and PDU sets, based on the instructions from the SMF. If the RAN node does not support the corresponding PDU Set based QoS parameters for the QOS flow, the RAN node becomes a broken link for managing end-to-end QoS for the QoS flows of the XRM services.

In another example, in the uplink (UL), the UE may continue to perform PDU set identification and marking for the PDUs from the XRM applications on the UE as well as enforce QoS flow mapping for the PDUs and PDU sets, based on the instructions from the SMF. If the RAN node does not support the corresponding PDU Set based QoS parameters for the QoS flow, the RAN node becomes a broken link for managing end-to-end QoS for the QoS flows of the XRM services. As such, in both examples, the network experiences unnecessary signaling overheads for PDU set based handling and waste of energy and computing power.

Various solutions to solve the abovementioned issues for the 5GC are now discussed with regard to the figures. The following embodiments assume that the RAN node may or may not support XRM services capabilities for PDU set based handling, the UE may or may not support XRM services capabilities for PDU set based handling, and XRM is XR and Media Services.

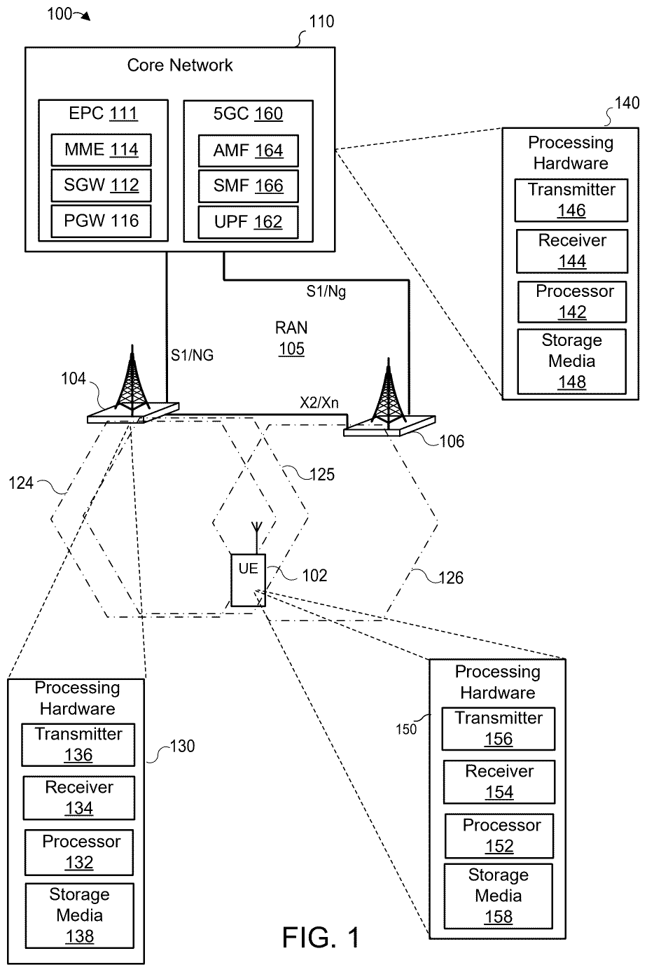

Before discussing these various solutions, a possible 5GS 100 is presented, as illustrated in FIG. 1. 5GS 100 includes a UE 102, a first base station (BS) 104, a second BS 106, and a CN element 110. The term base station is used in this description as a generic name for a radio access network node. The BSs 104 and 106 may operate in a RAN 105 connected to the CN element 110. The CN element 110 may be implemented as an evolved packet core (EPC) 111 (i.e., non-5G system) or a 5G core (5GC) 160, for example. The CN element 110 may also be implemented as a sixth generation (6G) core in another example.

The first BS 104 covers a first cell 124 and a second cell 125, and the second BS 106 covers a cell 126 in this example. If the first BS 104 is a gNB, the cells 124 and 125 are an NR cell. If the first BS 104 is an ng-eNB or eNB, the cells 124 and 125 are an evolved universal terrestrial radio access (E-UTRA) cell. The same is valid for the second BS 106. The cells 124, 125, and 126 may be in the same Radio Access Network Notification Areas (RNA) or different RNAs. In general, the RAN 105 can include any number of BSs, and each of the BSs can cover one, two, three, or any other suitable number of cells. The UE 102 can support at least a 5G NR (or simply, “NR”) or E-UTRA air interface to communicate with the BSs 104 and 106. Each of the BSs 104, 106 may connect to the CN element 110 via an interface (e.g., S1 or Ng interface, i.e., CN-based interface). The BSs 104 and 106 may also be interconnected via an interface (e.g., X2 or Xn interface) for interconnecting RAN node nodes (i.e., RAN node to RAN node interface).

Among other components, the EPC 111 can include a Serving Gateway (SGW) 112, a Mobility Management Entity (MME) 114, and a Packet Data Network Gateway (PGW) 116. SGW 112 in general is configured to transfer user-plane packets related to audio calls, video calls, Internet traffic, etc., and the MME 114 is configured to manage authentication, registration, paging, and other related functions. PGW 116 provides connectivity from the UE to one or more external packet data networks, e.g., an Internet network and/or an Internet Protocol (IP) Multimedia Subsystem (IMS) network. 5GC 160 includes a User Plane Function (UPF) 162, an Access and Mobility Management Function (AMF) 164, and/or a Session Management Function (SMF) 166. Each of these functions may be hosted by a corresponding processor or a common processor. Among other functionalities, UPF 162 is configured to transfer user-plane packets related to audio calls, video calls, Internet traffic, etc., AMF 164 is configured to manage authentication, registration, paging, and other related functions, and SMF 166 is configured to manage PDU sessions. The CN element 110 may also include processing hardware 140, processor 142, receiver 144, transmitter 146, and storage media 148, which are similar to the components 130, 132, 134, 136, and 138 of the first BS 102, respectively. These components are discussed next in more detail.

Because cells 124, 125, and 126 can partially overlap, the UE 102 can select, reselect, or hand over from one of the cells 124, 125, and 126 to another. To directly exchange messages or information (e.g., related to the handover procedure), the first BS 104 and second BS 106 may support an X2 or Xn interface, i.e., a dedicated protocol for exchanging messages between the BSs without involving the CN element 110. In addition, the BSs are connected through Ng interfaces to the CN element 110, which may connect to any suitable number of BSs supporting NR cells and/or EUTRA cells.

The first BS 104 is equipped with processing hardware 130 that can include one or more general-purpose processors (e.g., CPUs) and a non-transitory computer-readable memory storing instructions that the one or more general-purpose processors execute. Additionally, or alternatively, the processing hardware 130 can include special-purpose processing units. The processing hardware 130 in an example implementation includes a processor 132 to process data that the first BS 104 will transmit in the downlink (DL) direction, or process data received by the BS 104 in the uplink (UP) direction. The processing hardware 130 can also include a transmitter 136 configured to transmit data in the DL. The processing hardware further can include a receiver 134 configured to receive data in the uplink direction. The processing hardware 130 can also include a storage media 138 for storing instructions that are executed by the processor 132. The second BS 106 can include similar components.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. Processing hardware 150 may include a processor 152 to process data that the UE 102 will transmit in the UP, or process data received by UE 102 in the DL. The processing hardware 150 may also include a transmitter 156 configured to transmit data in the DL. The processing hardware may further include a receiver 154 configured to receive data in the UP. The processing hardware 150 may also include a storage media 158 for storing instructions that are executed by the processor 152.

According to an embodiment, the UE uses a registration procedure for obtaining one or more network slices that support XRM service. More specifically, the AMF of the CN element authorizes the UE to use XRM services based on the UE's XRM service capability and/or UE's subscription. For example, the UE's subscription includes a particular network slice, which is described by single-network selection assistance information (S-NSSAI), for the XRM service with specific PDU set based QoS requirements. The S-NSSAI is defined in 3GPP Technical Specification (TS) 23.501 and includes a slice/service type (SST), which refers to the expected network slice behaviour in terms of features and services, and a slice differentiator (SD), which is optional information that complements the SST to differentiate amongst multiple network slices of the same SST. The S-NSSAI can have standard values (e.g., S-NSSAI is only comprised of SST with a standardized SST value and no SD), or non-standard values (i.e., such S-NSSAI is comprised of either both an SST set as (e.g. HDLLC) and an SD) or only an SST without a standardized SST value and no SD. The SST value may be associated, for example, with the QoS requirements that require, for example, high data rate and low latency communications.

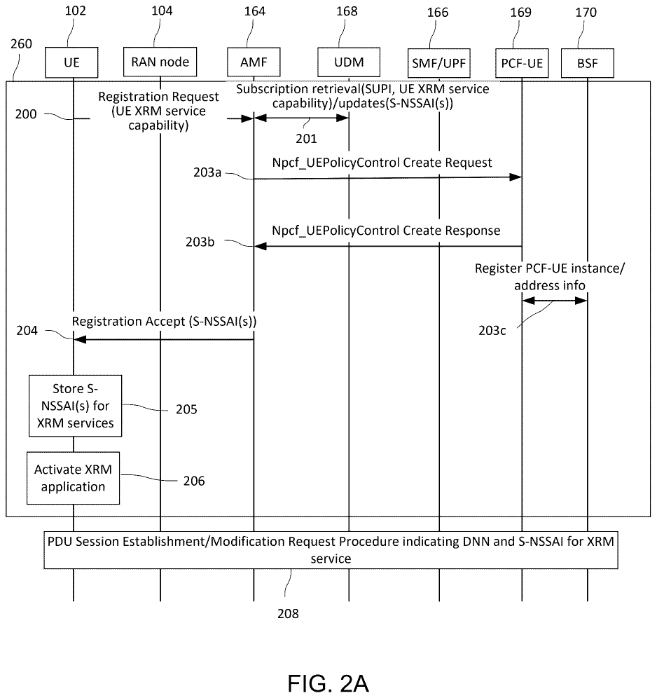

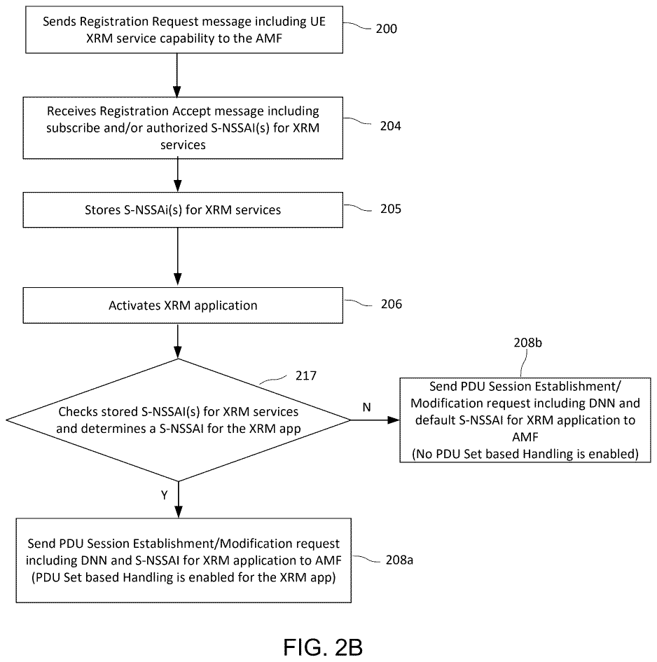

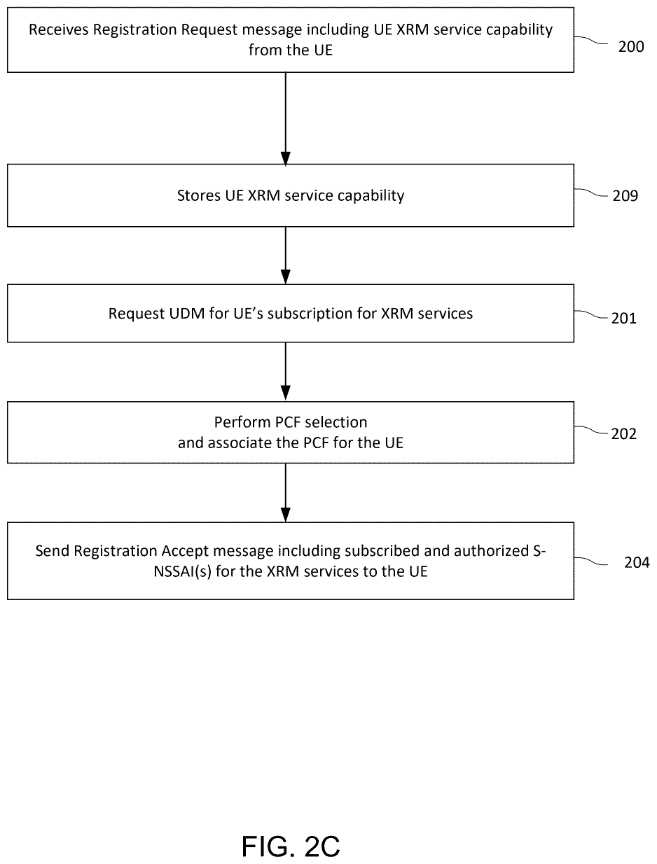

The policy control function (PCF) implemented by the CN element supports policy control and charging (PCC) rules for enabling PDU set based QoS parameters based on XRM services authorization and RAN node support of the XRM services for PDU Set based handling. If the UE is capable of XRM services, the UE enables PDU set handling for PDU set QoS flows based on an authorization of XRM services configured by the PCF. In this respect, the UE can obtain information of subscribed and/or authorized S-NSSAI for XRM services from the CN element, as part of the registration request procedure. When an XRM application is invoked at the UE, the UE may send a PDU session establishment/modification request message including a data network name (DNN) and a particular S-NSSAI (subscribed network slice) for the XRM service. These features are discussed in more detail with regard to FIG. 2A.

A modified registration procedure 260 (the traditional registration procedure is described in 3GPP TS 23.502) is illustrated in FIG. 2A, the UE behavior with regard to the registration procedure 260 is illustrated in FIG. 2B, and the AMF behavior with regard to the registration procedure 260 is illustrated in FIG. 2C. The traditional registration procedure is modified, as shown in FIG. 2A, so that the UE includes 200 the UE's XRM service capability, which may be part of the 5G mobility management (5GMM) capability, in the registration request message. The UE's XRM service capability indicates whether the UE 102 supports XRM service capabilities for PDU set based QoS handling, e.g., whether the UE 102 is authorized to use XRM service for UL, or whether the UE 102 is authorized to use XRM service for DL, or whether the UE 102 is authorized to use the XRM service. Note that in this document, the term “XRM service capability” is indicative of whether there is support or not for “PDU set based QoS handling.”

The AMF 164 obtains 201 the UE XRM service subscription data as part of the user subscription data from UDM 168 during the UE modified registration procedure 260 using, for example, Nudm_SDM service as defined in 3GPP TS 23.502. For example, the XRM service subscription data includes one or more network slices, defined by S-NSSAI(s), for the XRM services. The AMF determines whether the UE is authorized to use XRM services based on UE's XRM service capability and the XRM service authorization included in the subscription data received from UDM. If UE is authorized for the XRM services, the AMF stores the authorized UE XRM service capability. If the UE 102 is authorized to use the XRM services, then the AMF 164 discovers a PCF 169 via a network function repository function (NRF) for associating the UE 102 with the PCF 169 and sending the authorized UE XRM service capability for XRM service operation to the PCF 169.

These features are now discussed with regard to FIG. 2A. UE 102 sends 200 a registration request message including UE's XRM service capability as part of the 5GMM capability IE to the AMF 164. The AMF 164 requests 201 the UE's subscription from the UDM 168, by indicating UE's subscription permanent identifier (SUPI) and UE XRM service capability. AMF 164 then obtains the XRM service subscription data as part of the user subscription data including S-NSSAI(s) for the XRM services, for example, using the Nudm_SDM service. The AMF 164 determines whether the UE is authorized to use the XRM services based on UE's XRM service capability and the XRM service authorization included in the subscription data received from UDM. If UE is authorized for XRM services, the AMF stores the authorized XRM service capability.

The AMF 164 performs 203a/203b PCF 169 selection if the UE 102 is authorized for XRM services and establishes UE's Access and Mobility (AM) policy association with the PCF. PCF-UE 169 registers 203c its address and instance for the UE to binding support function (BSF) 170. The BSF is used for binding an application-function request to a specific PCF. This information can be used by the SMF 166 to select the same PCF 169 for the PDU session for the XRM services. Then, AMF 164 sends 204 a registration accept message, including information of authorized network slices (one or more S-NSSAI(s)) for XRM services, to the UE. The UE stores 205 the received S-NSSAI(s) for the XRM services and the UE activates 206 an XRM application and sends the PDU session establishment/modification request procedure 208 indicating a desired DNN and selected S-NSSAI for XRM services.

The behavior of the UE 102 during the procedures illustrated in FIG. 2A is now disclosed with regard to FIG. 2B. The UE sends 200 the UE's XRM service capability, which may be part of the “5GMM capability”, in the registration request procedure, as the UE's XRM service capability indicates at least one of the following information: (1) the UE is authorized to use XRM service for UL, (2) the UE is authorized to use XRM service for DL, or (3) the UE is authorized to use XRM service. The UE receives 204 a registration accept message including one or more subscribed/authorized S-NSSAI(s) which are associated to one or more XRM services. The UE stores 205 the received S-NSSAI(s) for the XRM services. The UE activates 206 an XRM application. Upon activation, the UE checks 217 the stored S-NSSAI(s) for XRM services and determines a S-NSSAI for the XRM application. If a stored S-NSSAI is selected for the XRM application, the UE sends 208a to the SMF, via AMF, a PDU session establishment/modification request message including the DNN and the selected S-NSSAI for the XRM services. A PDU set based handling is then enabled by the XRM application. If there is no S-NSSAI selected for the XRM application, the UE sends 208b a PDU session establishment/modification request message including the DNN and a default S-NSSAI, which may be default for XRM services or default for all services. No PDU set based handling is enabled for this case.

The behavior of the AMF 164 during the procedures illustrated in FIG. 2A is now disclosed with regard to FIG. 2C. The AMF receives 200 the registration request message including UE's XRM service capability from the UE. AMF 164 stores 209 the UE's XRM service capability for XRM service operation and requests 201 from the UDM 168, the UE's subscription and authorization for XRM services. AMF 164 performs 202 the PCF selection for the UE (PCF-UE) if the UE is authorized for XRM services and establishes UE's access and mobility (AM) policy association with the PCF. For simplicity, the PCF is assumed to be the same as the PCF for the PDU session (PCF-PS) later selected by the SMF. AMF 164 sends 204 the registration accept message to the UE, including information of authorized network slices (one or more S-NSSAI(s)) for the XRM services.

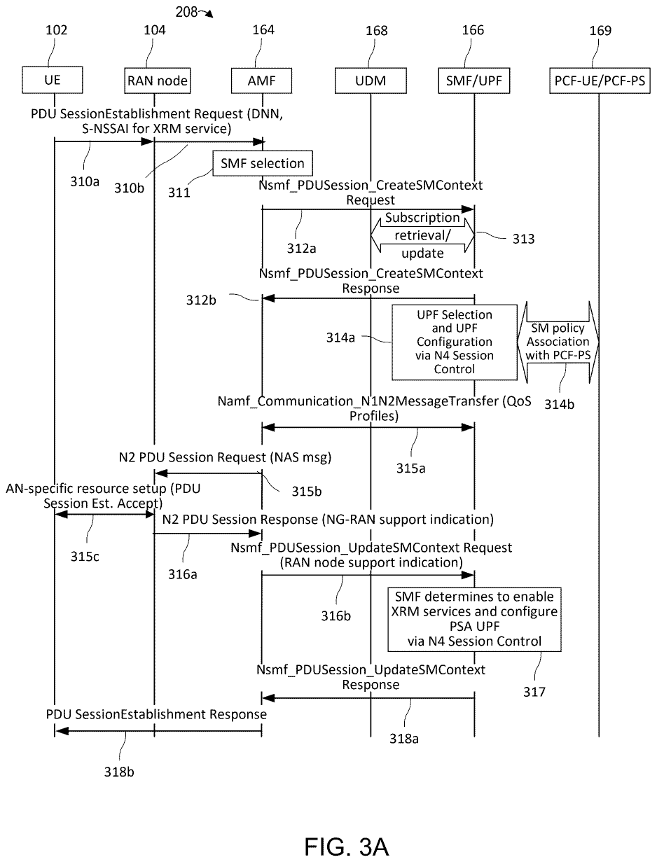

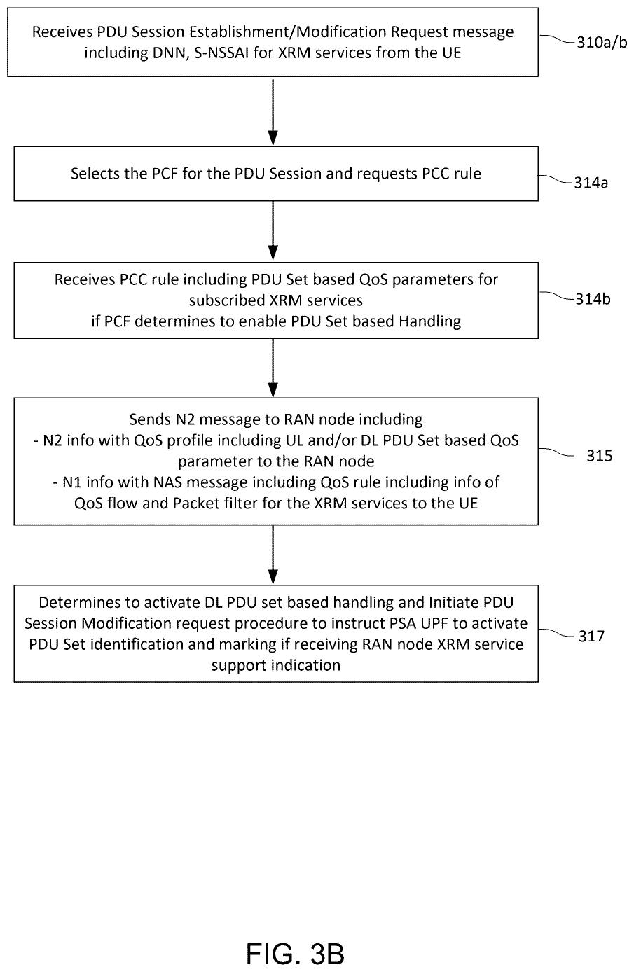

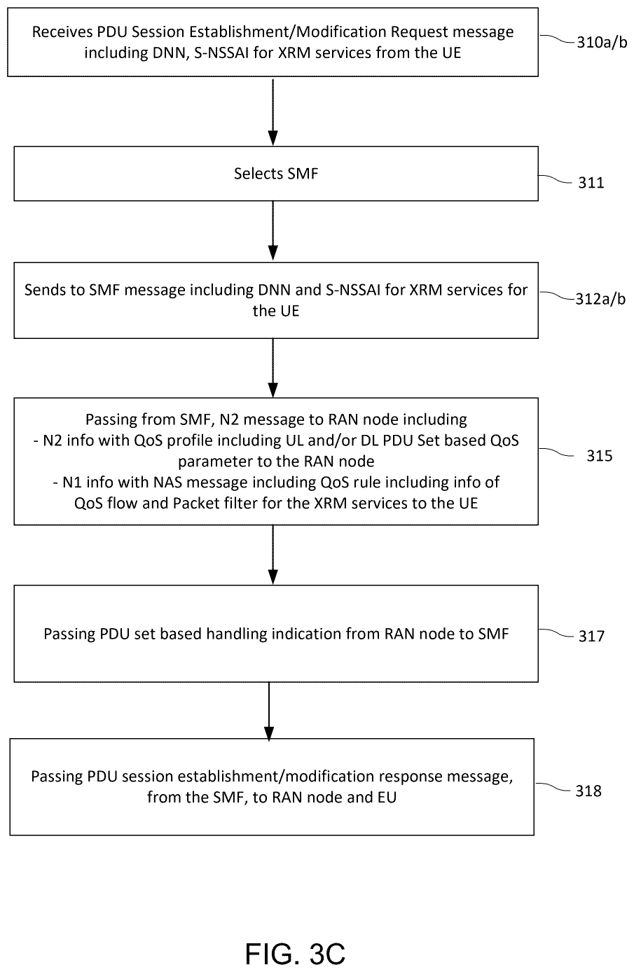

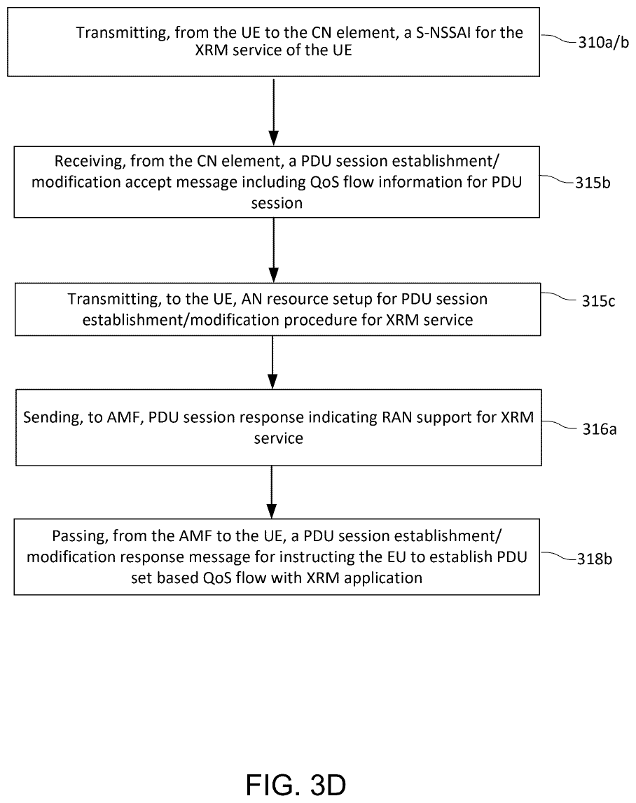

To use the subscribed XRM services, the UE and CN element perform a PDU session establishment or modification procedure. A modified PDU session establishment procedure 208 is now discussed with regard to FIG. 3A. The UE 102 sends 310a/b a PDU session establishment request message, including DNN and a selected S-NSSAI for XRM services, to AMF 164, via RAN node 104. AMF 164, based on the stored UE's XRM service capability, DNN, and the S-NSSAI, selects 311 an SMF 166 capable of PDU set based handling. AMF 164 sends 312a, for example, using an Nsmf_PDUSession_CreateSMContext request message, including the DNN and S-NSSAI, to the SMF 166. SMF 166 checks 313 with the UDM 168 the UE's subscription and authorization for the S-NSSAI for the XRM service. SMF 166 responds 312b to the AMF for creating the PDU session. If the UE does not have authorization and subscription for the S-NSSAI, the SMF sends a PDU session establishment/modification reject message including a cause value to the UE, and the procedure stops.

SMF 166 selects 314a the PCF 169 for the PDU session (assumed, for simplicity, to be the same as the PCF for the UE) and requests 314b PCC rules including PDU set based QoS parameters for the subscribed XRM services, if the PCF determines to enable PDU set based handling for the QoS flows of the PDU session associated with the DNN and S-NSSAI. Then, SMF sends N2 message including the following:
N2 SM info 315a including QoS profile with UL/DL PDU set based QoS parameters for the UL/DL PDU set based QoS flow; and
N1 NAS message 315b, 315c including PDU session establishment/modification accept message, including one or more QoS flow info: QoS rule and protocol description (represented by a standardized value or included in a container) for the PDU set based QoS flow of the PDU session.

If RAN node 104 supports PDU set based QoS handling, it sends 316a/b RAN node's XRM service capabilities for PDU Set based handling to the SMF 166, through the AMF 164. Based on this indication, the SMF 166 determines 317 to enable PDU set based handling, and instructs PSA UPF 169, in N4 message including PDU set based QoS parameters and Protocol Description indicating the header (e.g., real time transport protocol (RTP)/secure RTP (SRTP)), for PDU set based identification and marking. Alternatively, the SMF initiates PDU session modification procedure to update the PSA UPF 169 and/or UE. SMF 166 sends 318a/b a PDU session establishment/modification response message to the UE 102 through the AMF 64.

With this message, the UE 102 can perform the following:
for the DL XRM traffic, it maps the data radio bearer (DRB) to PDU set based QOS flow and forwards it to the XRM application,
for the UL XRM traffic, it determines whether to enable PDU set based handling (including UL PDU set identification and/or marking) for the XRM traffic received from the XRM application and maps the QoS flow to the DRB.

The SMF 166 behavior for the modified PDU session establishment 208 illustrated in FIG. 3A is now discussed with regard to FIG. 3B. The SMF 166 receives 310a/b a PDU session establishment request message, including DNN and a specific S-NSSAI for XRM services, from the UE 102, through the AMF 164. The SMF 166 selects 314a the PCF 169 for the PDU session and requests the PCC rule including PDU set based QoS parameters for the subscribed XRM services. The SMF 166 receives 314b the PCC rule including PDU set based QoS parameters for the subscribed S-NSSAI of the XRM services, if the PCF determines to activate the PDU set based handling for the PDU set based QoS flow of the PDU session. Then, the SMF 166 sends 315 an N2 message to the RAN node 104. The N2 message includes:
N2 SM info containing QoS profile with UL/DL PDU set based QoS parameters, and
N1 info containing NAS message including QoS rule with QoS flows and packet filters for the XRM services, which can be further delivered to the UE.

The SMF 166 determines 317 to activates the PDU set based handling and initiate PDU session modification request procedure which instructs PSA UPF to activate PDU set based handling via N4 message. The N4 message may include PDU set based QoS parameter and and Protocol Description indicating the header (e.g., real time transport protocol (RTP)/secure RTP (SRTP)) for PDU set based identification and marking.

AMF 164 behavior for the modified PDU session establishment 208 illustrated in FIG. 3A is now discussed with regard to FIG. 3C. The AMF 164 receives 310a/b from the UE the PDU session establishment/modification request message including the DNN and the S-NSSAI for XRM services. AMF 164 then selects 311 an SMF 166 and sends 312a/b to the SMF 166 a message including the DNN and S-NSSAI for XRM services for the UE. AMF 164 passes 315 from SMF 166 to the RAN node 104 the N2 message. The N2 message includes N2 info with QoS profile including UL and/or DL PDU set based QoS parameter to the RAN node 104. The N2 message further includes N1 info with NAS message including QoS rule including info of QoS flow and a packet filter for the XRM services to the UE. The AMF 164 further passes 317, from RAN node 104 to SMF 166, RAN node's XRM service capabilities for PDU Set based handling, and also passes 318 PDU session establishment/modification response message, from the SMF 166, to RAN node 104 and UE 102.

The RAN node 102 behavior for the modified PDU session establishment 208 illustrated in FIG. 3A is now discussed with regard to FIG. 3D. The RAN node transmits 310a/b a PDU session establishment/modification request message including DNN and S-NSSAI for XRM services to the CN element 110. RAN node 104 receives 315b, from the CN element, a PDU session establishment/modification accept message including QOS flow information for the PDU session and transmits 315c to UE, access network (AN) resource setup for PDU session establishment/modification procedure for the XRM service. RAN node 104 also sends 316a to AMF, a PDU session response indicating RAN support for the XRM service. RAN node 104 passes, from the AMF 164 to the UE 102, the PDU session establishment/modification response message for instructing the UE 102 to establish PDU set based QoS flow with XRM application.

The embodiments illustrated in FIGS. 3A to 3D may be modified as follows. In one variation of those embodiments, the UE does not indicate UE's XRM service capability in the registration request message 200 (discussed above with regard to FIGS. 2A to 2C), and the AMF sends 204 one or more S-NSSAI(s) in the registration accept message (without depending on UE's XRM service capability). Thus, instead of indicating UE's XRM service capability in the registration request message, the UE indicates UE's XRM service capability in the PDU session establishment/modification request message illustrated in FIG. 3A, steps 310a/b, which may be part of the 5GSM capability.

For this embodiment, the UE 102 sends 310a/b to the AMF 164, a PDU session establishment request message including DNN and a selected S-NSSAI for XRM services, and, different from FIG. 3A, the UE's XRM service capability, which may be part of the 5GMM capability. The AMF 164, based on received UE's XRM service capability, the DNN, and the S-NSSAI, selects 311 the SMF capable of PDU set based handling. The AMF 164 sends 312a, for example, Nsmf_PDUSession_CreateSMContext Request message, including the DNN and S-NSSAI, and the UE's XRM service capability, to the SMF 166. Based on UE's XRM service capability, DNN, and S-NSSAI, the SMF checks 313 with UDM for UE's subscription and authorization for the DNN and S-NSSAI for the XRM service. The remaining steps are similar to those described with regard to FIG. 3A.

The embodiments illustrated in FIGS. 3A to 3D may further be modified so that the UE 102 does not indicate the UE's XRM service capability in the registration request message (see FIG. 2A, step 200) or in the PDU session establishment/modification procedure (see FIG. 3A, steps 310a/b), and the AMF 164 sends one or more S-NSSAI(s) in the registration accept message (without depending on UE's XRM service capability). More specifically, with regard to FIG. 3B, the UE 102 sends 310a/b a PDU session establishment request message including DNN and a selected S-NSSAI, to the SMF 166, through AMF 164. The AMF 164 selects 311 the proper SMF based on the DNN and the selected S-NSSAI. AMF 164 sends 312a, to the SMF, for example, an Nsmf_PDUSession_CreateSMContext request message, including the DNN and the selected S-NSSAI. The SMF checks 313, based on the DNN and selected S-NSSAI, with the UDM, for the UE's subscription and authorization for the DNN and selected S-NSSAI. The remaining steps 312b to 318b in FIG. 3A are then performed without any modification.

Next, various additional embodiments are discussed, and each such embodiment may be combined with the embodiments related to FIGS. 2A to 3D. According to an embodiment, the PCF 169 is configured to query the RAN node's XRM service capability for PDU set based handling and subscribes to the AMF 164 notification for RAN node's XRM service capability for PDU set based handling when the serving RAN node is changed for the UE. For this embodiment, a new event identity (ID) is introduced for the new event exposure of RAN node's XRM service capability for PDU set based handling or RAN node's XRM service capability for PDU Set based handling changes for the UE serving RAN node. For this embodiment, AMF 164 sends a notification to the PCF 169, for example, in the EventExposure_Notify message. If the serving RAN node is capable of PDU set handling for XRM services, the PCF provides rules updates to all impacted SMFs for the PDU sessions of the new/existing PDU sessions based on the supported RAN node's XRM service capability for PDU set based handling or provides PCC rules to a SMF 166 for the new PDU session and/or new QoS flows. In addition to QoS parameters for the PDU handling, the PCC rules may contain PDU set QoS parameters and PDU set information if the PDU set based handling is activated and the RAN node's XRM service capability for PDU set based handling is supported. While the above description refers to event-based subscription for XRM service capability for PDU set based handling, this description may be applied to any other even-based subscription, i.e., non-XRM service capability.

For the XRM service capability for PDU set based handling, the SMF 166 performs, based on the PCC rules from the PCF, QoS flow binding and configures UPF for PDU set identification and marking according to the PDU session establishment procedure, PDU session modification procedure, and AF session with required QoS procedure, and/or AF session with required QoS update procedure, as disclosed in 3GPP TS 23.502. The PCF provisions the authorization of the XRM service to the UE 102 in step 203b in FIG. 2A by including one or more of the following: (1) whether the UE is authorized to use XRM Service for UL, (2) whether the UE is authorized to use XRM Service for DL, or (3) whether the UE is authorized to use XRM service.

With the XRM service authorization, the UE performs the following:
indicates to the upper layer to perform PDU set based handling for UL traffic received from the XRM application, and/or
maps one or more DRB(s) to the PDU set QoS flows of the XRM traffic received from the 5G network.

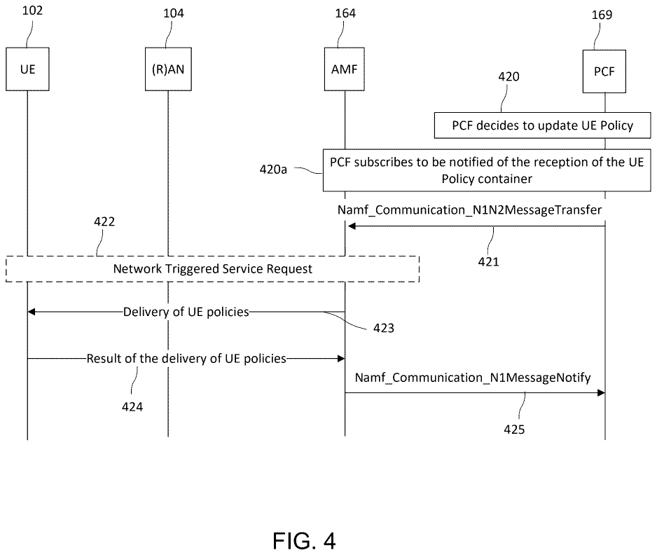

The above features are now discussed in more detail with regard to FIG. 4. FIG. 4 shows that PCF 169 configures UE 102 using a UE configuration update procedure, which is performed after the registration procedure 260 illustrated in FIG. 2A. The PCF decides 420 to update the UE policy and thus, the PCF subscribes 420a to the AMF 164, to be notified about the UE policy. Then, the PCF sends 421 a message, for example, an Namf_Communication_N1N2Message Transfer message including UE's XRM service authorization, to the UE's AM policy hosted by the AMF 164. An optional Network Triggered Service Request may be sent 422 to the UE 102. The AMF delivers 423 the UE's AM policies via DL NAS transport message to the UE 102, based on the UE configuration update procedure for transparent UE Policy delivery. UE 102 informs 424 the AMF about the result of the delivery of the UE policies and the AMF confirms 425 the same to the PCF.

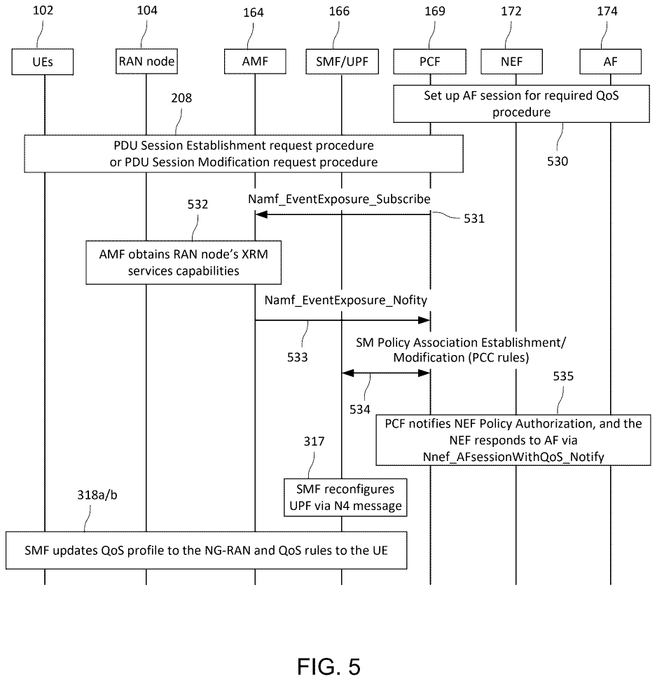

FIG. 5 shows in more detail the messages exchanged between the AMF, RAN node, and PCF for achieving the configuration of the UE with XRM service authorization. An AF session is established 530 based on a QoS procedure or based on AF session with required QoS update procedure. A PDU session establishment procedure or a PDU session modification procedure 208 is initiated next. The PCF 169 queries 531 the RAN node's XRM service capability for PDU set based handling, at the AMF 164, and subscribes to the AMF notification for a new event ID of the RAN node's XRM service capability of PDU set based handling for event exposure, when the UE's serving RAN node changes. RAN node 104 provides 532 its XRM services capabilities for PDU set based handling to the AMF. The AMF sends 533 a notification to the PCF in, for example, the Namf_EventExposure_Notify message, including RAN node's XRM services capabilities for PDU set based handling. Thus, in this way, the PCF is informed by the AMF about the RAN node's XRM capabilities for PDU set based handling.

The PCF determines 534 to provide/update the PCC rules via, for example, an Npcf_SMPolicyControl_UpdateNotify request, with updated policy information to all impacted SMFs for the new/existing PDU sessions based on the supported RAN node's XRM service capability for PDU set based handling. If the RAN node supports XRM service capabilities for PDU set based handling, the PCF configures PCC rules with PDU set QoS parameters and indicating the header (e.g., real time transport protocol (RTP)/secure RTP (SRTP)) for the SMF 166.

PCF 169 notifies 535 a NEF for the subscribed Policy Authorization for the RAN node's XRM service capabilities for PDU set based handling, and the NEF sends, for example, an Nnef_AFsessionWithQoS_Notify message with the event reported by the PCF to the AF. SMF 166 performs 317 QoS flow binding and configure UPF via N4 interface for PDU set identification and marking, based on the PCC rules. Then, SMF updates 318a the RAN node 104 with QoS profiles of PDU sessions and updates 318b the UE 102 with QoS rules during the PDU session establishment/modification procedures.

The AMF may become aware of the RAN node's XRM service capability for PDU set based handling based on various mechanisms. Traditionally, a RAN Configuration Update procedure is used to update application level configuration data needed for the RAN node and the AMF to correctly interoperate. The procedure uses non UE-associated signaling. This procedure is modified to account for the RAN node XRM service capabilities as follows.

According to an embodiment, which describes an option A, RAN node reports its XRM service capability for PDU set based handling to the AMF according to a non-UE associated N2 procedure. This procedure is used to inform the AMF whether the XRM service capabilities are activated or not at the RAN node. That is, the RAN node capable of XRM service for PDU set based handling can enable or disable its RAN node's XRM services capabilities for all its serving UEs per RAN node basis, which may be based on local configuration, or overload control.

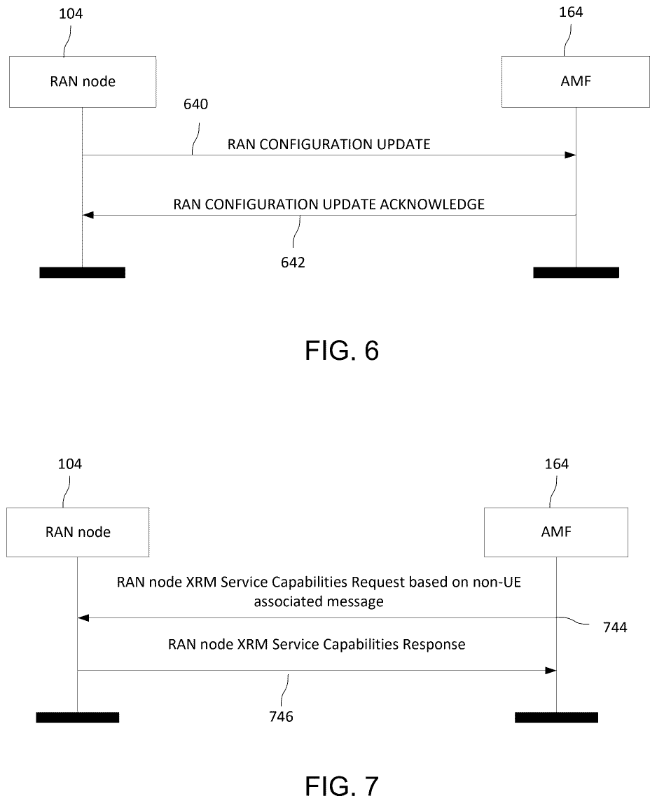

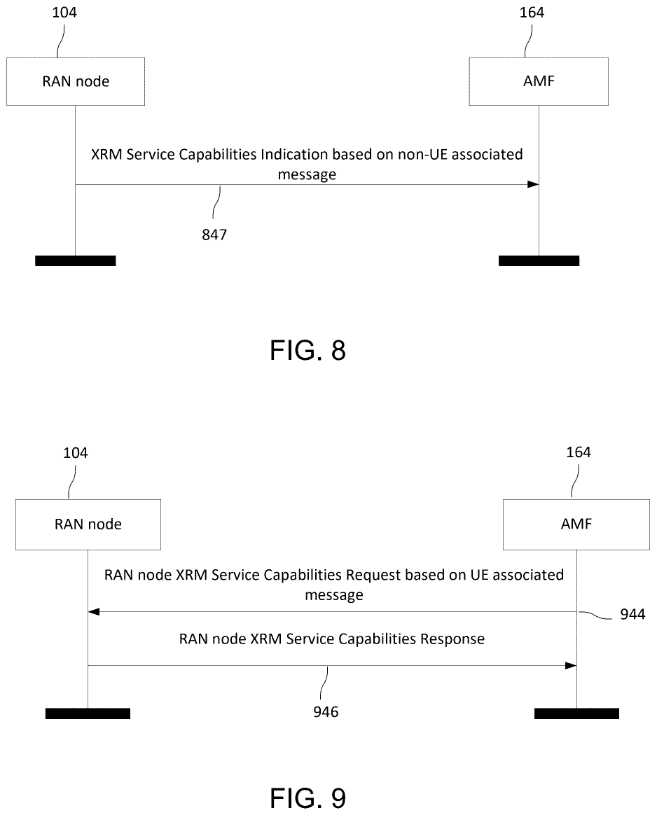

For example, FIG. 6 illustrates an existing non-UE associated N2 procedure, which is a RAN configuration update procedure as described in 3GPP TS 38.413, and includes the RAN node 104 sending 640 to the AMF 164, a RAN configuration update, and receiving 642, a RAN configuration update acknowledge. A modified procedure is illustrated in FIG. 7, which relies on a non-UE associated N2 message and is used to transfer RAN node's capabilities, e.g., XRM service capabilities. The non-UE associated N2 procedure is used by the AMF to request 744 RAN node's XRM service capabilities and the RAN node responds 746 with its XRM service capabilities. FIG. 8 illustrates the use of a new non-UE associated N2 message specifically used to transfer 847 RAN node's capabilities, e.g. XRM service capabilities for PDU Set based handling, to the AMF.

According to another embodiment, which describes an option B, the RAN node reports its XRM service capability for PDU set based handling, to AMF, based on a UE associated N2 procedure. The procedure is used to inform the AMF whether the XRM service capabilities are activated or not. That is, the RAN node capable of XRM service for PDU set based handling can enable or disable its XRM services capabilities on a per UE basis, based on a local configuration, or overload control.

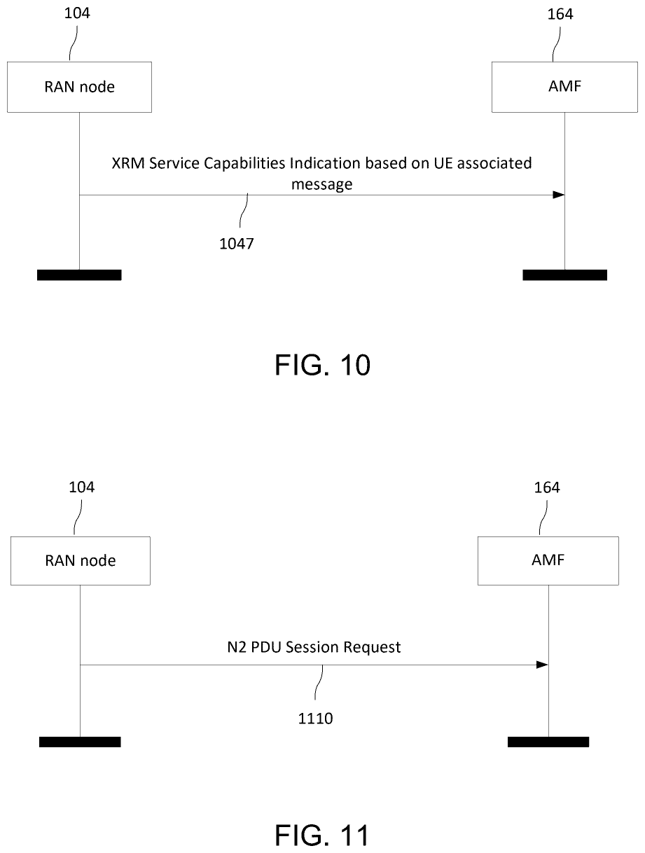

For example, as shown in FIG. 9, a UE associated N2 procedure is used by the AMF to request 944 RAN node's XRM service capabilities and the RAN node responds 946 with its XRM service capabilities. In another example, FIG. 10 shows a new UE-associated N2 message specifically used to transfer 1047 RAN node's XRM service capabilities for PDU Set based handling, e.g., XRM service capabilities indication, to the AMF.

According to yet another embodiment, which describes an option C illustrated in FIG. 11, the RAN node indicates 1110 its RAN node's XRM service capability for PDU Set based handling in a N2 message (corresponding to step 310) of the PDU session establishment/modification procedure 208 of FIG. 3A.

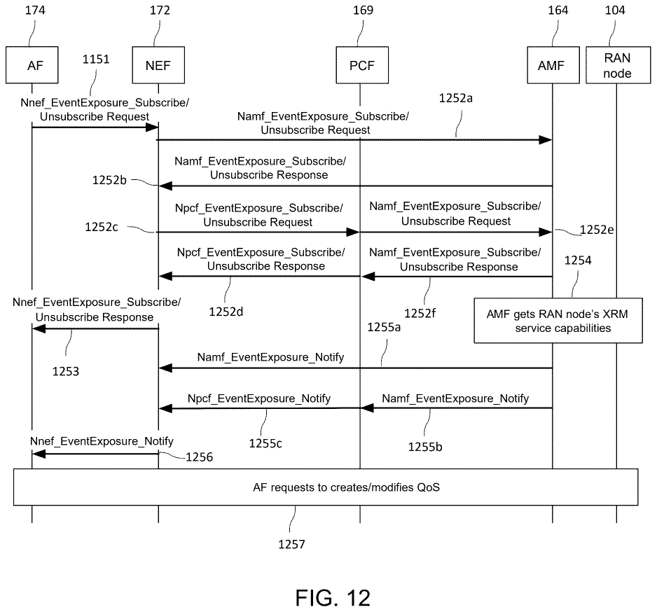

The RAN node's XRM service capability for PDU Set based handling may also be provided to the AF as now discussed with regard to FIG. 12. The AF 174 may receive the XRM service capability of the RAN node 104 via NEF 172 or directly from the PCF 169. The AF may subscribe to the AMF or PCF notification for RAN node's XRM service capability for PDU Set based handling when the UE serving RAN node is changed. A new Event ID is introduced for the new event exposure to the RAN node's XRM service capability for PDU Set based handling or RAN node's XRM service capability for PDU Set based handling changes for the UE's serving RAN node. With the event subscription, the AMF sends a notification to the PCF or NEF, for example, in the EventExposure_Notify message.

More specifically, the AF 174 requests an Event Exposure that includes one or more of the following parameters: target UE ID(s), event ID, event reporting criteria, validity criteria. The event ID is set for the RAN node's XRM service capability for PDU Set based handling when the UE's serving RAN node is changed. Event reporting criteria may be 1) always reporting when the serving RAN node is changed, or 2) reporting only when the RAN node's XRM service capability for PDU Set based handling is changed along with the change of the serving RAN node.

The target UE ID may be a generic public subscription identifier (GPSI), which represents an individual UE or a list of UEs, or an external group identifier, which represents a group of UEs. The NEF maps the GPSI in the target UE ID into SUPI or the external group identifier into an Internal Group Identifier, according to information received from UDM.

Validity criteria includes validity conditions for the AF request, such as time windows, target geographical area as the NEF maps the geographical area in Spatial Validity Condition into areas of validity determined by local configuration, which can be Area of Interest (AOI) to network functions, e.g., AMF, SMF, PCF, by referring to predefined areas that are represented by a list of Tracking Areas, list of cells or list of (R)AN node identifiers.

NEF 172 requests 1252a-1252b or 1252c-1252f Event Exposure service operation from AMF 164 or PCF 169, for example, with the Npcf_EventExposure_Subscribe message or Namf_EventExposure_Subscribe message, which includes the target UE ID, event ID of RAN node's XRM service capability for PDU Set based handling, event reporting criteria, and validity criteria.

NEF 172 responds 1253 to the AF 174, for example, in the Nnef_EventExposure_Subscribe response message or Namf_EventExposure_Subscribe response message, based on the information collected from the AMF 164 and/or PCF 169. AMF 164 obtains 1254 RAN node's XRM services capabilities for PDU set based handling through an N2 message from the RAN node 104. The PCF and/or AMF sends 1255a or 1255b to 1255c, a notification to the NEF in the Npcf_EventExposure_Notify or Namf_EventExposure_Notify messages, respectively, including the RAN node's XRM services capabilities for PDU set based handling. NEF 172 sends 1256 to the AF 174, for example, the Nnef_EventExposure_Notify message including the RAN node's XRM service capabilities for PDU set based handling. AF 174 determines 1257 whether to create, modify, activate, or deactivate the PDU set based QoS for the XRM services via, for example, an Nnef_AFsessionWithQoS_Create request procedure for the new or existing AF sessions for the required QoS.

In one embodiment, the SMF subscribes to the AMF notification for the RAN node's XRM service capability for PDU set based handling, when the UE's serving RAN node changes. For this embodiment, a new Event ID is introduced for the new event exposure to the RAN node's XRM service capability for PDU set based handling or RAN node's XRM service capability for PDU set based handling changes. When the new event occurs, the AMF sends a notification to the SMF, for example, in the EventExposure_Notify message.

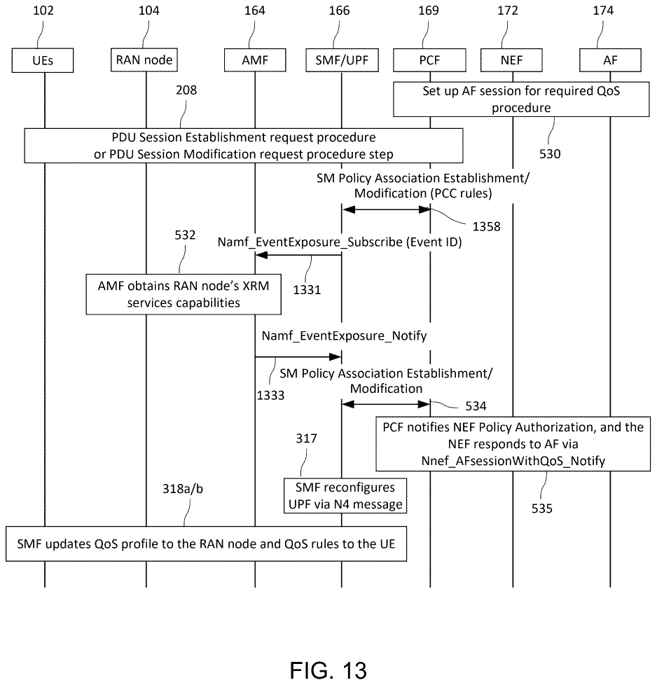

More specifically, with regard to FIG. 13, a PDU session is established/modified 208 as follows. An AF session is established 530 based on a required QoS procedure or AF session with required QoS update procedure. NEF 172 subscribes to a Policy Authorization for the RAN node's XRM service capabilities for PDU set based handling, from the PCF. The PDU session establishment/modification procedure 208 is initiated. SMF 166 performs 1358 an SM Policy Association and Modification procedure with the PCF 169 to obtain PCC rules, which may include PDU set QOS parameters and and Protocol Description indicating the header (e.g., real time transport protocol (RTP)/secure RTP (SRTP)), if applicable. SMF 166 queries 1331 the RAN node's XRM service capability for PDU set based handling from the AMF 164 and subscribes to the AMF's notification for RAN node's XRM service capability for PDU set based handling when the UE's serving RAN node is changed. RAN node 104 indicates 532 its XRM services capabilities for PDU set based handling to the AMF 164. AMF 164 sends 1333 a notification to the SMF 166, for example, in the Namf_EventExposure_Notify message, including RAN node's XRM services capabilities for PDU set based handling.

SMF 166 performs 534 the SM Policy Association and Modification procedure with the PCF 169 to obtain the PCC rules, which may include PDU set based QOS parameters and PDU set information, if applicable. PCF 169 notifies 535 NEF 172 about the subscribed Policy Authorization for the RAN node's XRM service capabilities, and the NEF sends, for example, an Nnef_AFsessionWith QoS_Notify message with the event reported by the PCF to the AF. SMF 166 performs 317 QoS flow binding for the service data flow of the XRM services, based on the RAN node's XRM service capability for PDU set based handling and PCC rules. The SMF configures the UPF via an N4 interface for PDU set identification and marking, if the RAN node supports XRM services capabilities for PDU set based handling.

Finally, SMF 166 updates 318a/b the RAN node with a QoS profile of the QOS flows for the PDU session, in a N2 message, and updates the UE with QoS rules, in an N1 PDU session accept message.

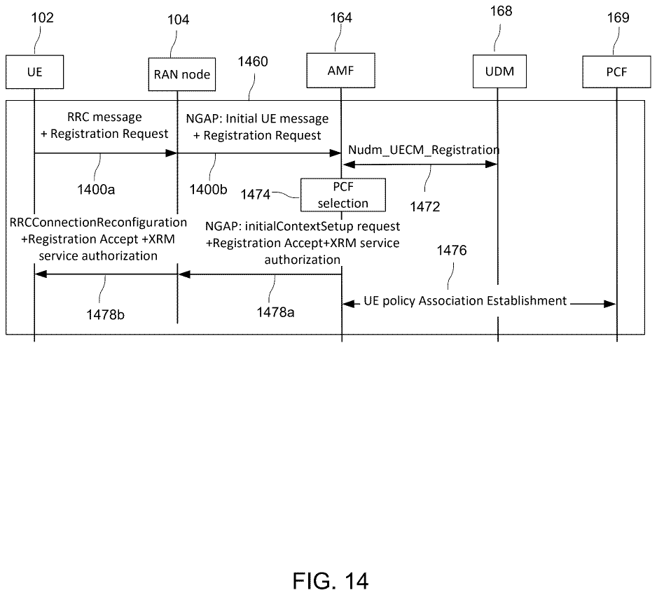

In a different embodiment, the RAN node's XRM capability for PDU Set based handling may be provided to the SMF via the AMF, per PDU session, as now discussed with regard to FIG. 14. The AMF may configure the RAN node with XRM service authorization via an Initial Context Setup request message associated with a registration request procedure 1460, which is a modification of the procedure 260 shown in FIG. 2A. The XRM service authorization may include one or more of: UE is authorized to use XRM service for UL; UE is authorized to use XRM service for DL; or UE is authorized to use XRM service. The RAN node capable of XRM services can perform PDU set based handling due to the XRM service authorization and information received from the SMF via N2 message and GTP-U header via N3 interface from the UPF.

The RAN node may also inform the UE about its XRM services. In one embodiment, after the RAN node receives an XRM service authorization, it includes an XRM service indication in an RRC message, e.g., RRCReconfiguration, which is sent to the UE in the registration procedure 1460, if the RAN node supports and enables its XRM service capabilities. This embodiment may be applied to at least two cases:
case 1: RRCReconfiguration message can be sent in the registration request procedure 1460, and
case 2: RRCReconfiguration message can be initiated by the RAN node when the RAN node enables or disables its XRM service capability for the UE.

The UE performs the following steps when the XRM service indication is present:
indicates to the upper layer to perform PDU set handling for UL XRM traffic received from the XRM application, and
maps one or more DRB(s) to the PDU set QoS flows of the DL XRM traffic received from the 5G network.

FIG. 14 illustrates the message flow for this embodiment. UE 102 sends 1400a/b a registration request message including the UE's XRM service capability as part of the 5GMM capability IE to the AMF 164. AMF 164 obtains 1472 the UE XRM service subscription data as part of the user subscription data from UDM 168, using, for example, the Nudm_SDM service. The AMF determines whether the UE is authorized to use XRM services based on UE's XRM service capability and the XRM service authorization, which is included in the subscription data received from UDM. If UE is authorized for XRM services, the AMF stores the authorized UE XRM service capability. AMF 164 performs 1474 PCF selection if the UE is authorized for XRM services. AMF 164 sends 1478a/b a registration accept message to the UE by configuring 1478a RAN node 104 with XRM service authorization via Initial Context Setup request message. If the RAN node supports XRM service capabilities for PDU set based handling, RAN node includes 1478b the XRM service authorization in the RRC message sent to the UE, using, for example, the RRCConnectionReconfiguration message. AMF 164 further establishes 1476 the UE access and mobility (AM) policy associated with the PCF 169.

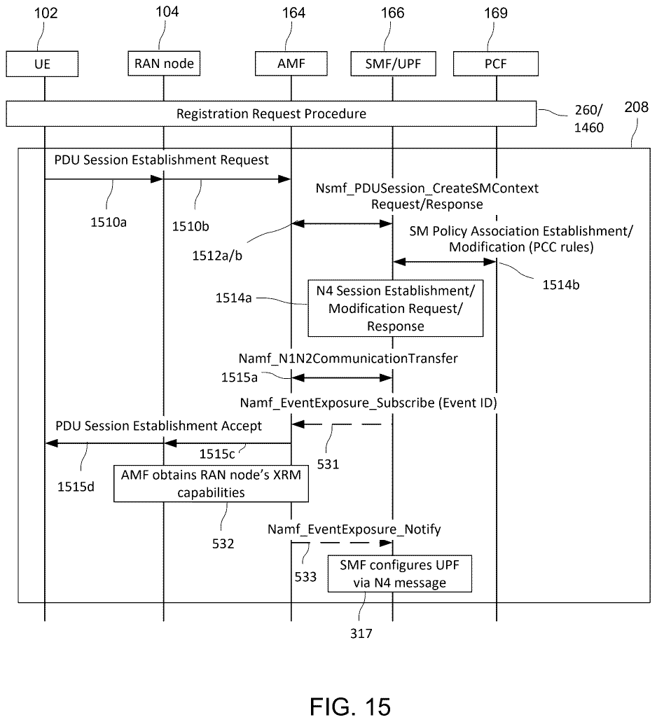

In one embodiment, if the RAN node UE context stores the UE authorization for XRM service, the RAN node indicates its XRM service capability to the SMF via AMF, for example, in the PDU session establishment or modification procedures 208, as now discussed with regard to FIG. 15. Based on the UE's XRM service authorization, the PCF provides PCC rules including PDU set QoS parameters and PDU set information to the SMF. The SMF performs, based on the RAN node's XRM service capability for PDU Set based handling and PCC rules, QoS flow binding and configures UPF for PDU set based handling and marking.

For example, during the PDU session establishment procedure 208, the XRM service indication can be provided, for example, in the message Namf_Communication_N1N2Message Transfer to the AMF, based on two options:
in option 1, the Namf_Communication_N1N2Message Transfer message includes the XRM service indication, a PDU session ID, N2 SM information, and N1 SM container, and Nsmf_PDUSession_SMContextStatusNotify.
in option 2, the Nsmf_PDUSession_SMContextStatusNotify message includes XRM service indication, which provides SMF-derived, CN-assisted RAN parameters tuning service. The AMF stores the SMF-derived, CN-assisted RAN parameters tuning in the associated PDU session context for this UE.

For PDU session establishment procedure 208, the RAN node capable of XRM services may perform PDU set based handling for the QoS flows in a PDU session based on the XRM service authorization and information received from the SMF via N2 message and GTP-U header via N3 interface from the UPF.

The message flows associated with this embodiment are discussed in more detail with regard to FIG. 15. The RAN node's XRM service capability for PDU Set based handling may be exposed to the SMF via AMF. The UE performs a registration request procedure 260/1460, and AMF 164 may configure RAN node with XRM service authorization via Initial Context Setup request message and the RAN node stores the XRM service authorization in the UE context. The RAN node receiving the XRM service authorization may include the XRM service indication in the RRC message, e.g. RRCReconfiguration, sent to the UE if the RAN node supports and enables its RAN node XRM service capabilities.

As part of the PDU session establishment 208, the UE sends 1510a a PDU session establishment request message to the SMF 166 via AMF 164, and the RAN node 104 indicates 1510b its XRM Service capabilities in an N2 message to the AMF 164 based on the XRM service authorization configured in 260/1460. AMF 164 sends 1512a, for example, an Nsmf_PDUSession_CreateSMContext request message to SMF 166, including RAN node's XRM service capabilities and receives 1512b, for example, an Nsmf_PDUSession_CreateSMContext response message from the SMF. SMF 166 performs 1514b SM Policy Association and Modification procedure with the PCF 169 to obtain the PCC rules, which may include PDU set based QoS parameters and Protocol Description indicating the header (e.g., real time transport protocol (RTP)/secure RTP (SRTP)), if applicable. SMF 166 also performs 1514a QoS flow binding, based on the received PCC rules, and configures UPF via N4 interface for PDU set identification and marking. SMF 166 sends an N4 session establishment/modification request to the UPF and the UPF acknowledges by sending an N4 session establishment/modification response.

SMF 166 queries 1515a AMF 164 about RAN node's XRM service capability for PDU Set based handling and subscribes 531 to the AMF's notification for the Event Exposure of RAN node's XRM service capability for PDU Set based handling when the UE's serving RAN node is changed. Alternatively, SMF 166 directly queries the RAN node's XRM service capability for PDU Set based handling, for example, through Namf_N2InfoSubscribe message to the RAN node via AMF. In a respond message, the RAN node sends the XRM service capabilities in Namf_N2InfoNotify message to the SMF via AMF. SMF 166 updates 1515c RAN node with QoS profiles of PDU sessions in N2 PDU session request message and updates 1515d UE with QoS rules in N1 PDU session accept establishment message. AMF 164 obtains 532 RAN node's XRM services capabilities from the RAN node 104 and sends 533 a notification to the SMF, for example, in the Namf_EventExposure_Notify message, including the RAN node's XRM services capabilities. SMF 166 performs 317 QoS flow binding and configures UPF via N4 interface for enabling PDU set identification and marking.

Numerical adjectives “first”, “second”, and “third” do not imply any order (are not ordinals) but are markers to distinguish separate instances of similar elements.

References to the singular (e.g., “a” or “an”, “the”) should include the plural unless clearly indicated otherwise.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

Although the features and elements of the present embodiments are described in the embodiments in particular combinations, each feature or element can be used alone without the other features and elements of the embodiments or in various combinations with or without other features and elements disclosed herein. The methods or flowcharts may be implemented in a computer program, software or firmware tangibly embodied in a computer-readable storage medium for execution by a specifically programmed computer or processor.

1-17. (canceled)

18. A wireless communication method performed by a core network, CN, element for establishing an extended reality and/or media, XRM, service, the method comprising:
receiving, from a user equipment, UE, a selected single-network slice selection assistance information, S-NSSAI, for the XRM service or an XRM capability of the UE;
checking, at a unified data management, UDM, a UE authorization for the S-NSSAI, before establishing a packet data unit, PDU, session associated with the selected S-NSSAI;
sending PDU set based quality-of-service, QoS, parameters to a radio access network, RAN, node; and
activating, at a user plane function, UPF, a PDU set based handling corresponding to the PDU based set QoS parameters, for a PDU set based QoS flow for the PDU session associated with a network slice corresponding to the selected S-NSSAI.

19. The method of claim 18, wherein the sending further comprising:
sending, to the UE, a QoS rule including QoS flow information related to the XRM service.

20. The method of claim 18, further comprising, prior to the sending:
selecting a policy control function, PCF, for the PDU session associated with the selected S-NSSAI, and
receiving, from the PCF, a policy and charging control, PCC, rule including the PDU set based QoS parameters.

21. The method of claim 18, the sending further comprising:
instructing, at a session management function, SMF, of the CN element, a PDU session anchor, PSA, UPF to activate PDU set identification and marking for the PDU set based QoS flow served by the PDU session associated with the selected S-NSSAI.

22. The method of claim 18, further comprising:
receiving, at an authentication and mobility management, AMF, of the CN element, the UE XRM capability in one of: a registration request message, a PDU session establishment request message, or a PDU session modification request message; and
sending, to the UE, one or more subscribed and/or authorized S-NSSAls associated with the UE XRM capability.

23. The method of claim 18, further comprising:
receiving from the UE, at an authentication and mobility management, AMF, of the CN element, one of: a registration request message, a PDU session establishment request message, or a PDU session modification request message, none of which includes the UE XRM capability; and
sending, to the UE, one or more subscribed and/or authorized S-NSSAls, independent of the UE XRM capability.

24. The method of claim 18, further comprising:
receiving RAN node's XRM service capabilities for PDU set based QoS handling at a session management function, SMF, or at an access and mobility management function, AMF, performed by the CN element.

25. The method of claim 18, further comprising:
receiving the UE XRM service capability through a registration procedure,
receiving a PDU session establishment request message or a PDU session modification request including the selected S-NSSAI, and
establishing or modifying the PDU session that is associated with the selected S-NSSAI.

26. The method of claim 18, wherein the S-NSSAI includes a slice service type, SST, that indicates a specific service associated with the network slice, and optionally includes a slice differentiator, SD, which distinguishes between different network slices, and the SST is set to high data rate and low latency communications for the XRM service.

27. A wireless communication method performed by a user equipment, UE, for establishing an extended reality and/or media, XRM, service, the method comprising:
receiving, from a core network, CN, element one or more subscribed and/or authorized single-network slice selection assistance information, S-NSSAls, associated with a UE XRM capability;
activating an XRM application; and
sending to the CN element a packet data unit, PDU, session establishment or modification request message including a selected S-NSSAI from the one or more subscribed and/or authorized S-NSSAIs, for the XRM application.

28. The method of claim 27, further comprising:
enabling a PDU set based handling for the XRM application based on the selected S-NSSAI.

29. The method of claim 27, wherein the selected S-NSSAI includes a slice service type, SST, that indicates a specific service associated with the network slice, and optionally includes a slice differentiator, SD, which distinguishes between different network slices, and the SST is set to high data rate and low latency communications for the XRM service.

30. A wireless communication method performed by a radio access network, RAN, node for providing packet data unit, PDU, set based quality-of-service, QoS, handling for an extended reality and/or media, XRM, service, the method comprising:
transmitting), from a user equipment, UE, to a core network, CN, element, a single-network slice selection assistance information, S-NSSAI, for the XRM service of the UE;
receiving, from the CN element, a PDU session establishment or modification message, including QoS flow information for the XRM service; and
sending, to the CN element, a PDU session response indicating support for the XRM service.

31. The method of claim 30, further comprising:
forwarding, from the CN element to the UE, a QoS rule in a PDU session related message for instructing the UE to use an established PDU set based QoS flow for an XRM application in the uplink direction.

32. The method of claim 30, wherein the S-NSSAI is independent of a UE XRM capability.

33. The method of claim 30, further comprising:
sending, to the CN element, through a PDU session establishment or modification procedure, a RAN node XRM service capability when a RAN node UE context stores an UE authorization for XRM service.

34. A core network element comprising:
a transceiver;
a processor; and
computer-readable storage media storing executable instructions for the processor to perform:
receiving, from a user equipment, UE, a single-network slice selection assistance information, S-NSSAI, for the XRM service or an XRM capability of the UE;
checking, at a unified data management, UDM, a UE authorization for the S-NSSAI, before establishing a packet data unit, PDU, session associated with the selected S-NSSAI;
sending PDU set based quality-of-service, QoS, parameters to a radio access network, RAN, node; and
activating, at a user plane function, UPF, a PDU set based handling corresponding to the PDU based set QoS parameters, for a PDU set based QoS flow for the PDU session associated with a network slice corresponding to the selected S-NSSAI.

35. The CN element of claim 34, wherein the processor is further configured to perform:
sending, to the UE, a QoS rule including QoS flow information related to the XRM service.

36. The CN element of claim 35, wherein the processor is further configured to perform, prior to the sending:
selecting a policy control function, PCF, for the PDU session associated with the selected S-NSSAI, and
receiving, from the PCF, a policy and charging control, PCC, rule including the PDU set based QoS parameters.
